(19) United States
(12) Patent Application Publication
(10) Pub. No.: US 2025/0065639 A1
(43) Pub. Date: Feb. 27, 2025

(54) PRINT HEAD AND METHOD OF MANUFACTURING PRINT HEAD

(71) Applicant: CANON KABUSHIKI KAISHA, Tokyo (JP)

(72) Inventors: SHIGEKI FUKUI, Kanagawa (JP); TATSUO NANJO, Kanagawa (JP); KEISUKE IINUMA, Kanagawa (JP); TAKAYUKI NAKAJIMA, Kanagawa (JP); SOJI KONDO, Kanagawa (JP); WATARU TAKAHASHI, Kanagawa (JP)

(21) Appl. No.: 18/813,726

(22) Filed: Aug. 23, 2024

(30) Foreign Application Priority Data
Aug. 25, 2023 (JP) 2023-137533

(51) Int. Cl. B41J 2/175; B41J 2/165; B41J 2/185; B41J 2/19

(52) U.S. Cl. CPC B41J 2/17559; B41J 2/16532; B41J 2/19; B41J 2002/1853; B41J 2202/07; B41J 2202/22

(57) ABSTRACT

Provided are a print head and a method of manufacturing a print head which can reduce the number of parts and simplify the manufacturing process. A method includes: preparing first and second lid members as a lid member, the first lid member including a supply port through which an accommodation chamber can be supplied with a liquid, the second lid member not including the supply port; manufacturing a first print head by joining the first lid member to a housing, the first print head configured to eject the liquid from ejection ports with the accommodation chamber supplied with the liquid through the supply port; and manufacturing a second print head by joining the second lid member to the housing, the second print head being detachably attachable to a printing apparatus and configured to eject the liquid from the ejection ports without the accommodation chamber supplied with the liquid.

### BACKGROUND OF THE INVENTION

### Field of the Invention

The present invention relates to a print head and a method of manufacturing a print head.

### Description of the Related Art

Print heads mounted on serial inkjet printing apparatuses include an accommodation chamber capable of accommodating a liquid, an ejection unit that ejects the liquid, and a channel member that guides the liquid from the accommodation chamber to the ejection unit. In such a print head, bubbles are generated inside the channel as the print head is used, and it is necessary to keep those bubbles from moving into the ejection unit and affecting images.

Japanese Patent Laid-Open No. H09-183230 discloses a disposable-type print head which is replaceable on a printing apparatus and in which a channel is provided at an intermediate portion with a relatively wide space capable of gathering and accommodating bubbles generated in the channel by utilizing buoyancy. By providing such a reservoir portion for bubbles inside the channel, the disposable-type print head can keep the generated bubbles from affecting ejection operations until the ink in the accommodation chamber is used up and the print head is replaced.

Here, there is a continuous ink supply-type print head that is supplied with an ink through a tube or the like as an ink held inside the print head is consumed. The continuous ink supply-type print head typically performs a suction operation to remove the ink containing bubbles from its ejection ports. In this case, it is preferable to make the channel width in the channel member as narrow as possible to achieve a high suction pressure for efficient suction.

Thus, the appropriate channel configuration is different between the disposable type, which can be replaced when the ink is used up, and the continuous ink supply type, which can perform a printing operation while being supplied with the ink through a tube or the like, and therefore these two types cannot be used interchangeably. For this reason, it has been difficult to commonize the manufacturing process for the disposable-type print head and the continuous ink supply-type print head, which has led to problems such as an increased number of parts and complicated manufacturing processes.

### SUMMARY OF THE INVENTION

In view of the above, the present disclosure provides a print head and a method of manufacturing a print head which can reduce the number of parts and simplify the manufacturing process.

To this end, the method of manufacturing a print head of the present disclosure is a method of manufacturing a print head including a printing element board having an ejection port array being an array of a plurality of ejection ports for ejecting a liquid, a housing including a box part in which an accommodation chamber to accommodate the liquid is formed, and a channel formation part in which a channel capable of supplying the liquid in the accommodation chamber to the ejection port array is formed, and a lid member covering an opening of the box part to define the accommodation chamber, the method including: preparing a first lid member and a second lid member as the lid member, the first lid member including a supply port through which the accommodation chamber can be supplied with the liquid, the second lid member not including the supply port; manufacturing a first print head by joining the first lid member to the housing, the first print head being capable of ejecting the liquid from the ejection ports with the accommodation chamber supplied with the liquid through the supply port; and manufacturing a second print head by joining the second lid member to the housing, the second print head being detachably attachable to a printing apparatus and capable of ejecting the liquid from the ejection ports without the accommodation chamber supplied with the liquid.

In accordance with the present disclosure, it is possible to provide a print head and a method of manufacturing a print head which can reduce the number of parts and simplify the manufacturing process.

Further features of the present disclosure will become apparent from the following description of exemplary embodiments with reference to the attached drawings.

### BRIEF DESCRIPTION OF THE DRAWINGS

FIG. 1 is a schematic diagram illustrating an inkjet printing apparatus;

FIG. 2 is a perspective view illustrating outer appearance of a cartridge;

FIG. 3 is an exploded perspective view of the cartridge;

FIG. 4 is a top view illustrating a case of the cartridge;

FIG. 5 is a cross-sectional view along the line V-V of FIG. 4;

FIGS. 6A to 6C are views each illustrating a channel part;

FIG. 7 is a perspective view of spaces as channels extracted, modeled, and illustrated as the channel part;

FIGS. 8A to 8C are views each illustrating the channel part;

FIGS. 9A to 9C are views each illustrating the channel part;

FIGS. 10A to 10C are views each illustrating the channel part; and

FIGS. 11A to 11C are views each illustrating a conventional cartridge.

### DESCRIPTION OF THE EMBODIMENTS

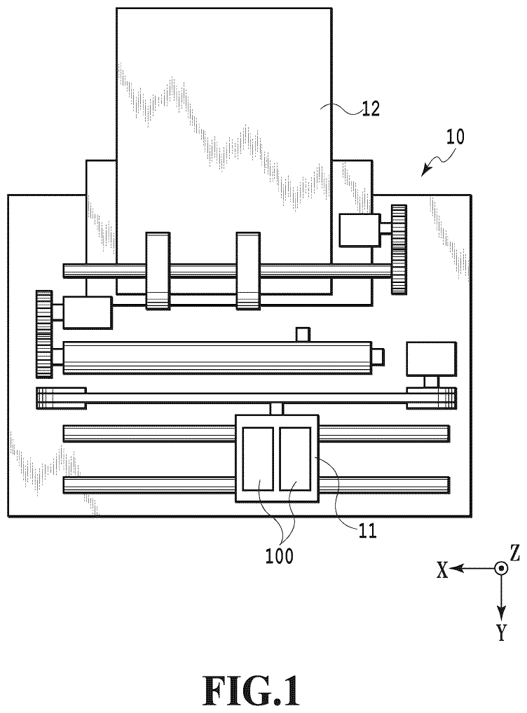

FIG. 1 is a schematic view illustrating an inkjet printing apparatus (hereinafter referred to also as “liquid ejection apparatus) 10 to which the following embodiment is applicable. In the drawing, the X direction represents the scanning direction of a carriage, the Y direction represents the conveyance direction of a print medium, and the Z direction represents the vertically upward direction. Note that the same X, Y, and Z axes as those in FIG. 1 are illustrated in the following drawings for explaining a single print head (hereinafter referred to also as “cartridge”) on the assumption that the cartridge is mounted to the printing apparatus. A liquid ejection apparatus 10 is configured such that cartridges 100 can be mounted on a carriage 11. The cartridges 100 mounted on the carriage 11 eject liquids (hereinafter referred to also as “inks”) onto a print medium 103 while moving relative to it to perform printing. In other words, the liquid ejection apparatus 10 is a serial printing apparatus. In the ejection, the cartridges 100 eject the liquids while the carriage 11 moves reciprocally in the X direction. In synchronization with the liquid ejection from the cartridges 100, the print medium 12 is conveyed at intervals of a predetermined distance in a direction orthogonal to the direction of the reciprocal movement of the carriage 11 (Y direction) to form an image on the print medium 12.

Note that while the cartridges 100 are illustrated in FIG. 1 as disposable-type cartridges that are detachably attachable to the carriage 11, the cartridges 100 may be of a continuous ink supply type. In this case, the inkjet printing apparatus 10 is provided with ink tanks of a relatively large capacity storing inks that can be supplied to the cartridges 100, and tubes capable of supplying the inks to the print heads from the ink tanks while following the movement of the cartridges 100.

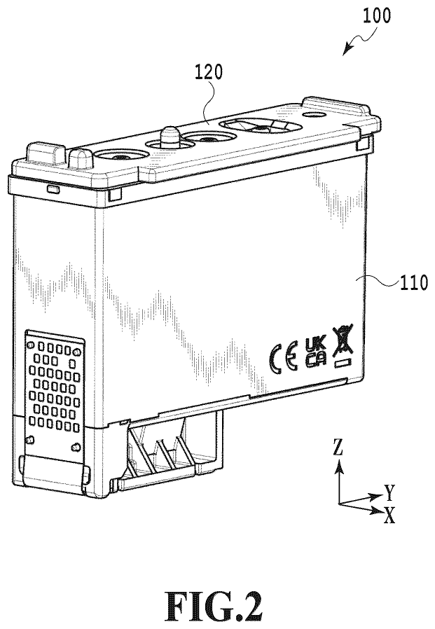

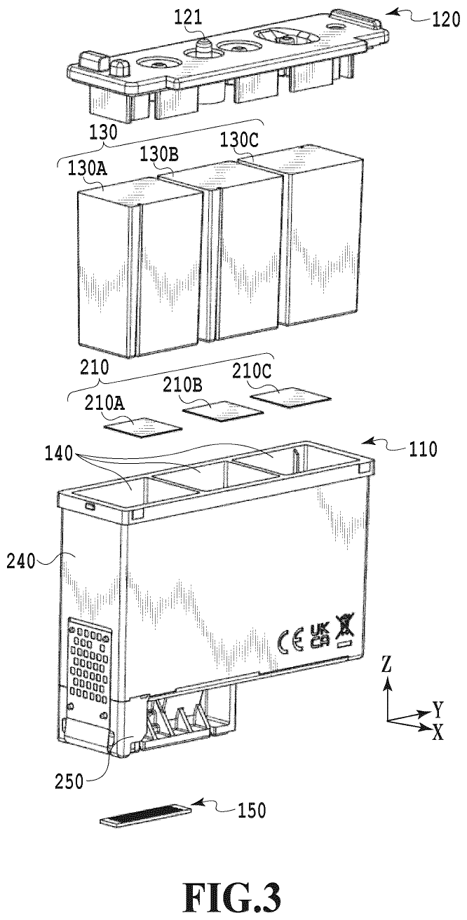

FIG. 2 is a perspective view illustrating outer appearance of one of the cartridges 100. FIG. 3 is an exploded perspective view of the cartridge 100. The cartridge 100 includes a printing element board 150 for ejecting the liquids, a case (housing) 110 in which accommodation chambers 140 for accommodating the liquids are formed, and a lid (lid member) 120. Filters 210 and absorbers 130 that hold the liquids to be accommodated are stored in the accommodation chambers 140. The liquids held in the absorbers 130 will be supplied to multiple ejection ports in the printing element board 150 through a channel part (not illustrated in FIGS. 2 and 3) communicating with the accommodation chambers 140. In the present embodiment, the absorbers 130 are inserted in the accommodation chambers 140 as means for generating negative pressures to hold the liquids, but the liquids can be similarly held also with a configuration employing negative pressure generation units such as pressure control units or circulation units. The disposable-type cartridge 100 is configured to be detachably attachable to the carriage 11 of the liquid ejection apparatus 10.

The liquids accommodated in the accommodation chambers 140 are usually chromatic color inks. Cyan, magenta, and yellow inks are accommodated in the accommodation chambers. Incidentally, while the configuration in which the cartridge 100 includes three accommodation chambers 140 will be exemplarily described in the present embodiment, the present embodiment is not limited to this configuration, and is applicable to cases with four or more accommodation chambers. For example, the following concept similarly applies to a cartridge accommodating four colors of inks additionally including a black ink.

The liquid ejection apparatus 10 also performs a maintenance operation that sucks the liquids out of the ejection ports by applying a negative pressure to the ejection ports. By this maintenance operation, bubbles generated as a result of liquid ejection and the like are discharged from the ejection ports together with the liquids.

In FIG. 3, three absorbers 130A, 130B, and 130C for cyan, magenta, and yellow are illustrated. The shapes of the absorbers 130 are desirably close to a cube for the ease of supply of the liquids. Here, in a case of changing the sizes of the absorbers 130 in consideration of the liquid capacities, it is preferable to extend the absorbers 300 in the direction of gravity (Z direction). Increasing the sizes of the absorbers 130 in the scanning direction (X direction) widens the cartridge 100, which in turn increases the size of the whole apparatus. Also, increasing the sizes of the absorbers 130 in the array direction of the ejection ports (Y direction) lengthens channels from the absorbers 130 to the printing element board 150 and increases the flow resistance in the supply of the liquids, which is not preferable.

The absorbers 130 are made of a fibrous material, a porous material, or the like, and are capable of holding the inks inside with capillary forces acting thereon. The absorbers 130 are stored in the accommodation chambers 140 of the case 110 in abutment with the respective filters 210 serving as dust traps, and the liquids inside the absorbers 130 are supplied to the printing element board 150 through the filters 210 and the channel part.

The printing element board 150 is an ejection unit that ejects the inks, and is disposed on (attached to) the bottom surface of the case 110 on the lower side in the direction of gravity. The printing element board 150 includes heating resistance elements not illustrated, and generates bubbles in the liquids with heat from the heating resistance elements and ejects the liquids from the ejection ports with the energy of the generated bubbles. The printing element board 150 is disposed around the bottoms of the absorber 130A and the absorber 130B and is distant from the absorber 130C. The case 110 has a box part 240 in which the accommodation chambers 140 are formed and a channel formation part 250 protruding in the −Z direction from the box part 240. The printing element board 150 is attached to the −Z side of the channel formation part 250. Specifically, the printing element board 150 is disposed on the bottom surface of the whole cartridge 100 and, when ejecting the liquids, ejects the liquids from a close distance to the print medium 12. The heating resistance elements of the printing element board 150 may be configured to be different in size between the disposable type and the continuous ink supply type.

The lid 120 is disposed so as to close the opening of the case 110, and defines the accommodation chambers 140 for accommodating the absorbers 130. Also, the configuration of the lid 120 is different between the disposable type and the continuous ink supply type. FIG. 3 illustrates the lid 120 for the continuous ink supply type. The lid 120 for the disposable type includes an atmosphere communication port not illustrated, through which external air can be taken in in the amount of the liquids inside the absorbers 130 consumed by ejection. The lid 120 for the continuous ink supply type is provided with supply ports 121 through which the accommodation chambers can be supplied with the liquids. The lid 120 for the disposable type is not provided with the supply port. In the manufacturing process, the lid 120 for the disposable type and the lid 120 for the continuous ink supply type are prepared.

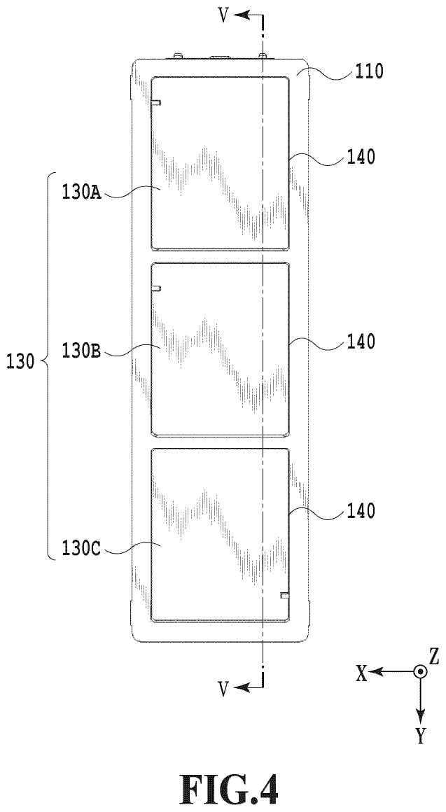

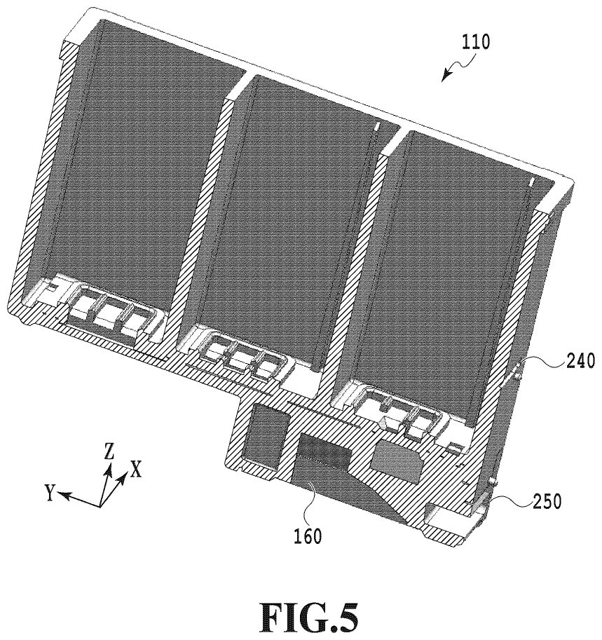

FIG. 4 is a top view illustrating the case 110 of the cartridge 100, and FIG. 5 is a cross-sectional view along the V-V line of FIG. 4. Note that illustration of the absorbers 130 is omitted in FIG. 5.

In the cartridge 100 in the present embodiment, the inside of the case 110 is partitioned to form the three accommodation chambers 140 such that the absorbers 130A, 130B, and 130C can be disposed side by side in the Y direction. The cartridge 100 is moved in the +X direction or the −X direction when mounted on and scanned with the carriage 11. The printing element board 150 includes ejection port arrays 1101 formed by arraying ejection ports in the Y direction. In sum, the absorbers 130A, 130B, and 130C are disposed along a direction which is the same as the array direction of the ejection ports and crosses (in the present embodiment, orthogonally crosses) the scanning direction.

The case 110 is formed by molding resin. In the formation of the case 110, the channel formation part 250 and the box part 240 are separately molded (primary molding), and then the channel formation part 250 and the box part 240 are joined (secondary molding). Note that the secondary molding may use a method which involves making spaces between the abutting portions of the box part 240 and the channel formation part 250 and pouring resin into these spaces, or use other connecting methods such as bonding. By separately molding the channel formation part 250 and the box part 240 and then joining the channel formation part 250 and the box part 240 as described above, channels can be formed in the case 110. Incidentally, in the present embodiment, the accommodation chambers 140 are arrayed at equal intervals, but the intervals do not need to be equal.

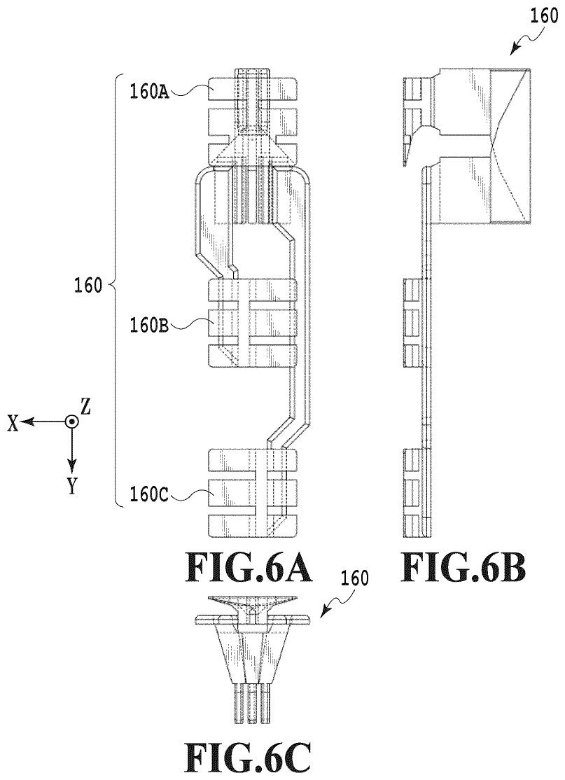

FIG. 6A is a top view of a channel part 160, FIG. 6B is a front view of the channel part 160, and FIG. 6C is a side view of the channel part 160. The channel part 160 is a model obtained by extracting the channels for the inks formed by the box part 240 and the channel formation part 250, and includes channels for the three colors (160A, 160B, and 160C). These channels are independent of one another. Specifically, as illustrated in FIG. 6A, the channels 160A, 160B, and 160C are disposed in this order in the Y direction. Such a channel part 160 is configured to be capable of supplying the liquids in the accommodation chambers 140 to the printing element board 150.

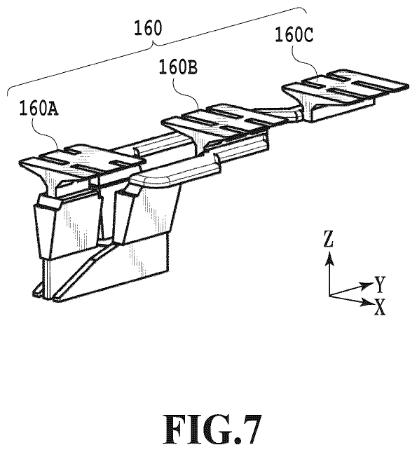

FIG. 7 is a perspective view of spaces as channels for the liquids inside the case 110 extracted, modeled, and illustrated as the channel part 160.

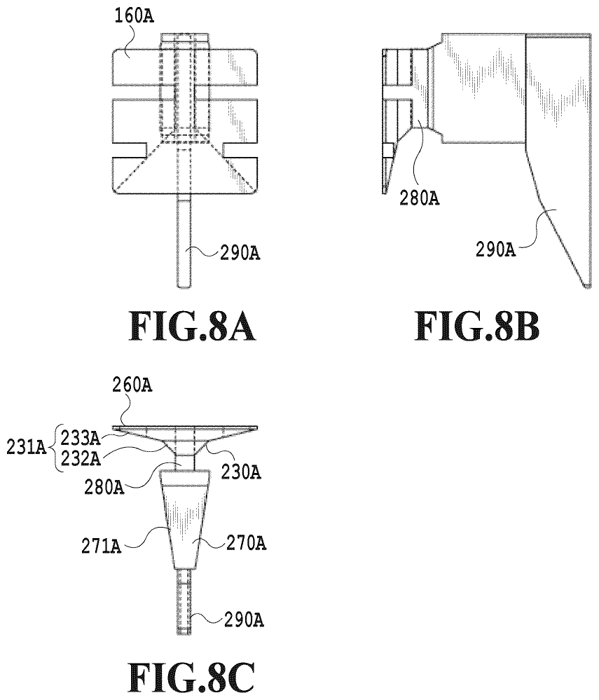

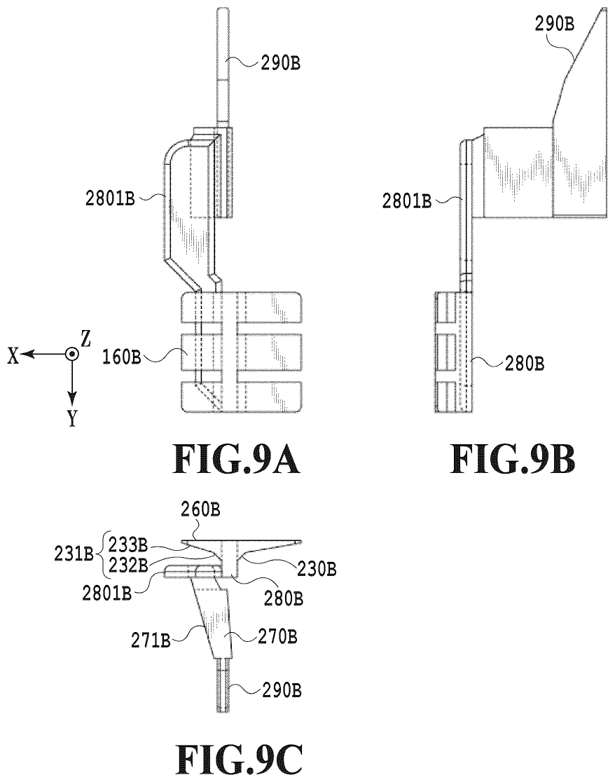

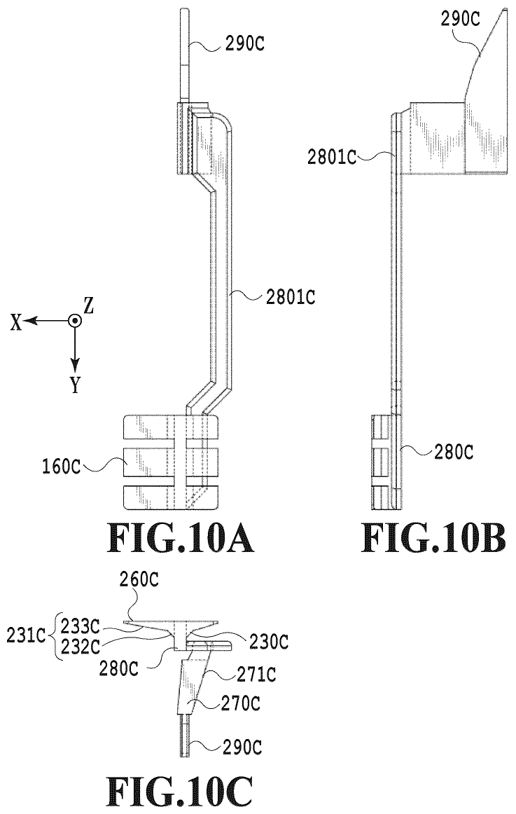

FIG. 8A is a top view of the channel 160A, FIG. 8B is a side view of the channel 160A, and FIG. 8C is a front view of the channel 160A. FIG. 9A is a top view of the channel 160B, FIG. 9B is a side view of the channel 160B, and FIG. 9C is a front view of the channel 160B. FIG. 10A is a top view of the channel 160C, FIG. 10B is a side view of the channel 160C, and FIG. 10C is a front view of the channel 160C.

As illustrated in FIGS. 8A to 8C, the channel 160A includes an opening portion 260A where a filter 210A is provided, a first reservoir portion (air buffer) 270A, a second reservoir portion 230A, and a narrow channel 280A connecting the first reservoir portion 270A and the second reservoir portion 230A. The channel 160A further includes a connection channel 290A to be connected to the printing element board 150. The first reservoir portion 270A and the second reservoir portion 230A have large capacities as compared to the other regions and are capable of storing (holding) bubbles generated as a result of ejection and the like.

The opening portion 260A is an opening that receives the liquid which has passed through the filter 210A, and is located at the bottom surface of the accommodation chamber 140 accommodating the absorber 130A. The first and second reservoir portions 270A and 230A are formed to be spaces which become wider toward the upper side in the vertical direction. Specifically, to be a space that becomes wider toward the upper side in the vertical direction, the first reservoir portion 270A is provided with a tapered portion 271A, and the second reservoir portion 230A is also provided with a tapered portion 231A. Such a configuration can collect bubbles generated inside the channel by utilizing buoyancy and keep the bubbles from approaching the ejection ports.

Also, in order that bubbles inside the first reservoir portion 270A can be discharged from the ejection ports by a suction operation performed by the liquid ejection apparatus 10, the first reservoir portion 270A has an optimum cross-sectional area as viewed from the suction direction. Moreover, in order to be able to impart a sufficient liquid flow velocity to discharge the bubbles inside the first reservoir portion 270A during the suction operation, the narrow channel 280A connected to the upstream side of the first reservoir portion 270A has a cross-sectional area smaller than the cross-sectional area of the first reservoir portion 270A as viewed from the suction direction. Specifically, in FIG. 8A, the cross-sectional area of the first reservoir portion 270A (the area of the dashed rectangle) is sufficiently large. Also, in FIG. 8C, the cross-sectional area of the narrow channel 280A (the area of the rectangle) is sufficiently smaller than the cross-sectional area of the first reservoir portion 270A (the area of the trapezoid).

At the second reservoir portion 230A, two tapers, namely a first tapered portion 232A and a second tapered portion 233A, are formed in order to move bubbles through the narrow space toward the filter. To let bubbles move upward while preventing formation of a meniscus, the angle of the first tapered portion 232A with respect to the horizontal direction is preferably 10 degree or more and 80 degrees or less, more preferably 20 degrees or more and 60 degrees or less, and further preferably 30 degrees or more and 50 degrees or less. At the second reservoir portion 230A, the distance from the space in the second reservoir portion 230A to the filter 210A needs to be short to increase the flow velocity of the ink that is caused to flow in a recovery operation, such as suction. To that end, the angle of the second tapered portion 233A with respect to the horizontal direction is preferably 45 degrees or less, more preferably 30 degrees or less, and further preferably 20 degrees or less.

The first reservoir portion 270A is connected to the connection channel 290A, and the connection channel 290A is connected to an ejection port array in the printing element board 150.

As illustrated in FIGS. 9A to 9C, the channel 160B includes an opening portion 260B where a filter 210B is provided, a first reservoir portion (air buffer) 270B, a second reservoir portion 230B, a narrow channel 280B connecting the first reservoir portion 270B and the second reservoir portion 230B, and a connection channel 290B.

The opening portion 260B is an opening that receives the liquid which has passed through the filter 210B, and is located at the bottom surface of the accommodation chamber 140 accommodating the absorber 130B. The narrow channel 280B connecting the first reservoir portion 270A, which is provided near the nozzle arrays, and the second reservoir portion 230B, which is provided near the accommodation chamber, includes a horizontal portion 2801B extending in the Y direction. Also, the first and second reservoir portions 270B and 230B are formed to be spaces which become wider toward the upper side in the vertical direction. To be a space that becomes wider toward the upper side in the vertical direction, the first reservoir portion 270B is provided with a tapered portion 271B, and the second reservoir portion 230B is provided with two tapers, namely a first tapered portion 232B and a second tapered portion 233B. Such a configuration can collect bubbles generated inside the channel by utilizing buoyancy and keep the bubbles from approaching the ejection ports.

Also, in order that bubbles inside the first reservoir portion 270B can be discharged from the ejection ports by a maintenance operation performed by the liquid ejection apparatus 10, the first reservoir portion 270B has an optimum cross-sectional area. Moreover, the narrow channel 280B connected to the upstream side of the first reservoir portion 270B has a cross-sectional area smaller than the cross-sectional area of the first reservoir portion 270B which can impart a sufficient liquid flow velocity to discharge the bubbles inside the first reservoir portion 270B during the maintenance operation. Specifically, in FIG. 9A, the cross-sectional area of the first reservoir portion 270B (the area of the dashed rectangle) is sufficiently large. Also, in FIG. 9C, the cross-sectional area of the narrow channel 280B (the area of the horizontal portion 2801B) is sufficiently smaller than the cross-sectional area of the first reservoir portion 270B (the area of the trapezoid).

To let bubbles move upward while preventing formation of a meniscus, the angle of the first tapered portion 232B with respect to the horizontal direction is preferably 10 degree or more and 80 degrees or less, more preferably 20 degrees or more and 60 degrees or less, and further preferably 30 degrees or more and 50 degrees or less. At the second reservoir portion 230B, the distance from the space in the second reservoir portion 230B to the filter 210B needs to be short to increase the flow velocity of the ink that is caused to flow in a recovery operation, such as suction. To that end, the angle of the second tapered portion 233B with respect to the horizontal direction is preferably 45 degrees or less, more preferably 30 degrees or less, and further preferably 20 degrees or less.

The first reservoir portion 270B is connected to the connection channel 290B, and the connection channel 290B is connected to an ejection port array in the printing element board 150.

As illustrated in FIG. 10A, the channel 160C includes an opening portion 260C where a filter 210C is provided, a first reservoir portion (air buffer) 270C, a second reservoir portion 230C, a narrow channel 280C connecting the first reservoir portion 270C and the second reservoir portion 230C, and a connection channel 290C.

The opening portion 260C is an opening that receives the liquid which has passed through the filter 210C, and is located at the bottom surface of the accommodation chamber 140 accommodating the absorber 130C. The narrow channel 280C connecting the first reservoir portion 270C, which is provided near the nozzle arrays, and the second reservoir portion 230C, which is provided near the accommodation chamber, includes a horizontal portion 2801C extending in the Y direction. Also, the first and second reservoir portions 270C and 230C are formed to be spaces which become wider toward the upper side in the vertical direction. To be a space that becomes wider toward the upper side in the vertical direction, the first reservoir portion 270C is provided with a tapered portion 271C, and the second reservoir portion 230C is provided with two tapers, namely a first tapered portion 232C and a second tapered portion 233C. Such a configuration can collect bubbles generated inside the channel by utilizing buoyancy and keep the bubbles from approaching the ejection ports.

Also, in order that bubbles inside the first reservoir portion 270C can be discharged from the ejection ports by a maintenance operation performed by the liquid ejection apparatus 10, the first reservoir portion 270C has an optimum cross-sectional area. Moreover, the narrow channel 280C connected to the upstream side of the first reservoir portion 270C has a cross-sectional area smaller than the cross-sectional area of the first reservoir portion 270C which can impart a sufficient liquid flow velocity to discharge the bubbles inside the first reservoir portion 270C during the maintenance operation. Specifically, in FIG. 10A, the cross-sectional area of the first reservoir portion 270C (the area of the dashed rectangle) is sufficiently large. Also, in FIG. 10C, the cross-sectional area of the narrow channel 280C (the area of the horizontal portion 2801C) is sufficiently smaller than the cross-sectional area of the first reservoir portion 270C (the area of the trapezoid).

To let bubbles move upward while preventing formation of a meniscus, the angle of the first tapered portion 232C with respect to the horizontal direction is preferably 10 degree or more and 80 degrees or less, more preferably 20 degrees or more and 60 degrees or less, and further preferably 30 degrees or more and 50 degrees or less. At the second reservoir portion 230C, the distance from the space in the second reservoir portion 230C to the filter 210C needs to be short to increase the flow velocity of the ink that is caused to flow in a recovery operation, such as suction. To that end, the angle of the second tapered portion 233C with respect to the horizontal direction is desirably 45 degrees or less, more desirably 30 degrees or less, and further desirably 20 degrees or less.

The first reservoir portion 270C is connected to the connection channel 290C, and the connection channel 290C is connected to an ejection port array in the printing element board 150.

As described above, the channels 160 in the cartridge 100 in the present embodiment each include a first reservoir portion capable of holding bubbles. The first reservoir portion has such a cross-sectional area that bubbles can be removed with a liquid flow velocity generated by a maintenance operation, extends in the vertical direction, and has a small channel with a small cross-sectional area on the upstream side connected to the first reservoir portion. With such a structure, the disposable-type cartridge retains generated bubbles in the first reservoir portion and keeps the bubbles from affecting ejection operations until the cartridge is replaced. On the other hand, the continuous ink supply-type cartridge can efficiently remove the bubbles retained in the first reservoir portion in a suction operation. In other words, the channel formation part 250 in the present embodiment described above can be used interchangeably for the disposable type and the continuous ink supply type, and thus commonize part of the manufacturing processes for these types of print heads. This makes it possible to provide a print head and a method of manufacturing a print head which can reduce the number of parts and simplify the manufacturing process.

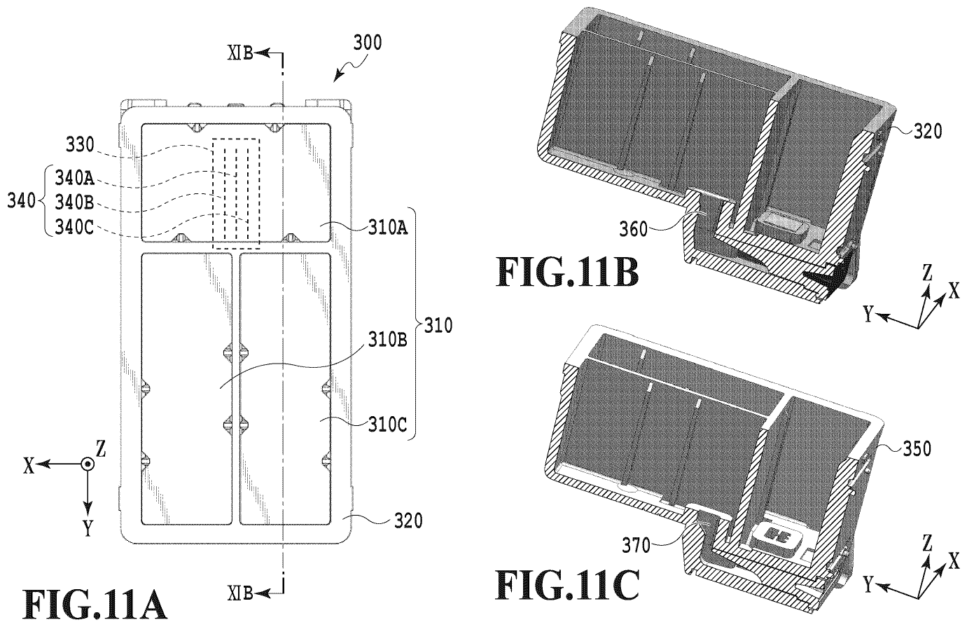

FIGS. 11A to 11C are views each illustrating a conventional cartridge 300 to be described as a comparative example of the present embodiment. FIG. 11A illustrates a top view of a case 320 (350) of the cartridge 300 with its lid detached. Three absorbers 310 are disposed inside the case 320 (350) of the cartridge 300, and liquids are held in the absorbers 310. The cartridge 300 is mounted on a carriage not illustrated and ejects the liquids while moving in the X direction. The liquids are supplied from the absorbers 310 containing the liquids to a printing element board 330 (depicted with the dashed line) through channels. The inside of the cartridge 300 is divided in a T-shape, and an absorber 310 is provided in each of the divided sections. In the cartridge 300, absorbers 310B and 310C are arrayed in the X direction, which is the scanning direction. The liquid held in the absorber 310B is ejected from an ejection port array 340B, and the liquid held in the absorber 310C is ejected from an ejection port array 340C.

FIG. 11B is a cross-sectional view along the XIB-XIB line of FIG. 11A. Note that illustration of the absorbers 310 is omitted in FIG. 11B. The cartridge 300 is a disposable-type cartridge, and is replaced with another cartridge in a case where the inks held inside are used up.

The case 320 of the cartridge 300 includes channels 360 for supplying the liquids to the printing element board 330 from the absorbers 310. The channels 360 are provided individually for the three absorbers 310, and supply the liquids from the respective absorbers 310 to the respective ejection port arrays 340 in the printing element board 330. Since the cartridge 300 is a disposable-type cartridge, the channels 360 serve also as bubble reservoir portions. The channels 360 have a sufficient capacity to store bubbles therein. This makes it possible to store generated bubbles without affecting the ejection of the liquids until the cartridge is replaced.

FIG. 11C is a cross-sectional view illustrating the case 350 of a conventional the continuous ink supply-type cartridge. The case 350 includes channels 370 for supplying the liquids to the printing element board 330 from the absorbers 310. The channels 370 are provided individually for the three absorbers 310, and supply the liquids from the respective absorbers 310 to the respective ejection port arrays 340 in the printing element board 330.

The continuous ink supply-type cartridge is configured to be capable of removing the inks containing bubbles from the ejection ports by performing a suction operation. Thus, the channels 370 each include a portion with a small area that is orthogonal to the direction in which the liquid is sucked, i.e., a small channel cross-sectional area, and with a narrow channel width. This allows a high suction pressure to efficiently discharge bubbles.

As described above, the channel shape in the conventional configuration is different between the disposable type and the continuous ink supply type. For this reason, the disposable-type cartridge cannot be used as a continuous ink supply-type print head, and two types of housings are necessary for the disposable type and the continuous ink supply type. This increases the number of parts and complicates the manufacturing process.

However, having the configuration of the present embodiment makes it possible to provide a print head and a method of manufacturing a print head which can reduce the number of parts and simplify the manufacturing process.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-137533, filed Aug. 25, 2023, which is hereby incorporated by reference wherein in its entirety.

What is claimed is:

1. A method of manufacturing a print head including
a printing element board having an ejection port array being an array of a plurality of ejection ports for ejecting a liquid,
a housing including
a box part in which an accommodation chamber to accommodate the liquid is formed, and
a channel formation part in which a channel configured to supply the liquid in the accommodation chamber to the ejection port array is formed, and
a lid member covering an opening of the box part to define the accommodation chamber,
the method comprising:
preparing a first lid member and a second lid member as the lid member, the first lid member including a supply port through which the accommodation chamber can be supplied with the liquid, the second lid member not including the supply port;
manufacturing a first print head by joining the first lid member to the housing, the first print head configured to eject the liquid from the ejection ports with the accommodation chamber supplied with the liquid through the supply port; and
manufacturing a second print head by joining the second lid member to the housing, the second print head being detachably attachable to a printing apparatus and configured to eject the liquid from the ejection ports without the accommodation chamber supplied with the liquid.

2. The method of manufacturing a print head according to claim 1, wherein the channel has
a first air buffer configured to hold a bubble generated in the channel and discharging the bubble in a case where a suction operation of sucking the liquid from the ejection ports is performed, and
a narrow channel connected to an upstream side of the first air buffer, and has a cross-sectional area smaller than a cross-sectional area of the first air buffer as viewed from a direction in which the liquid flows in the suction operation.

3. The method of manufacturing a print head according to claim 1, wherein an atmosphere communication port through which to communicate with an atmosphere is formed in the second lid member.

4. The method of manufacturing a print head according to claim 2, wherein the first air buffer has a tapered portion as a space which becomes wider toward an upper side in a vertical direction in a state where the print head is mounted to a printing apparatus.

5. The method of manufacturing a print head according to claim 2, wherein the channel further has a second air buffer connected to an upstream side of the narrow channel and configured to hold a bubble generated in the channel.

6. The method of manufacturing a print head according to claim 5, wherein the second air buffer has a tapered portion as a space which becomes wider toward an upper side in a vertical direction in a state where the print head is mounted to a printing apparatus.

7. The method of manufacturing a print head according to claim 1, further comprising:
shaping the box part and the channel formation part; and
forming the housing by joining the shaped box part and the shaped channel formation part.

8. The method of manufacturing a print head according to claim 1, further comprising attaching the printing element board to the housing such that the channel and the plurality of ejection ports are continuous with each other.

9. The method of manufacturing a print head according to claim 8, wherein the printing element board attached to the housing in the attaching is provided with a heating resistance element that differs in size between the first print head and the second print head.

10. A print head comprising:
a printing element board having an ejection port array being an array of a plurality of ejection ports for ejecting a liquid;
a housing including
a box part in which an accommodation chamber to accommodate the liquid is formed, and
a channel formation part in which a channel configured to supply the liquid in the accommodation chamber to the ejection port array is formed; and
a lid member covering an opening of the housing to define the accommodation chamber, wherein
the channel includes
a first air buffer configured to hold a bubble generated in the channel and discharging the bubble in a case where a suction operation of sucking the liquid from the ejection ports is performed, and
a narrow channel connected to an upstream side of the first air buffer, and has a cross-sectional area smaller than a cross-sectional area of the first air buffer as viewed from a direction in which the liquid flows in the suction operation.

11. The print head according to claim 10, wherein the first air buffer has a tapered portion as a space which becomes wider toward an upper side in a vertical direction in a state where the print head is mounted to a printing apparatus.

12. The print head according to claim 10, wherein the channel further has a second air buffer connected to an upstream side of the narrow channel and configured to hold a bubble generated in the channel.

13. The print head according to claim 12, wherein the second air buffer has a tapered portion as a space which becomes wider toward an upper side in a vertical direction in a state where the print head is mounted to a printing apparatus.
